(19) United States
(12) Patent Application Publication
(10) Pub. No.: US 2016/0052330 A1
(43) Pub. Date: Feb. 25, 2016

(54) Multiuse Decorative Covers

(71) Applicant: Tracey Nicole Cunningham, Windsor Mill, MD (US)

(72) Inventor: Tracey Nicole Cunningham, Windsor Mill, MD (US)

(21) Appl. No.: 14/464,438

(22) Filed: Aug. 20, 2014

(51) Int. Cl. B44C 1/10

(52) U.S. Cl. CPC B44C 1/10

(57) ABSTRACT

A multiuse, multifunctional decorative cover for household, office, place of business, automobile related, or items in any space, comprising a sheet of fabric or material further comprising a structure with a minimum of one opening. The opening(s) could consist of an opening and closing mechanism, such as a zipper, button, Velcro, etc., in order to form an enclosure, or the cover may also be designed to remain freely open. The opening(s) may have a continuous edge which is folded and stitched to form a channel along the edge of the opening. A closure, such as a drawstring or elastic ribbon, may be enclosed within such channel for securely adjusting said cover on the particular item. The opening(s) may also be created with an edge that doesn't contain a channel, but rather the cover may be made such that it fits the item wherein no additional securing mechanism is necessary. The interior portion of the edge(s) may contain a component for adhesion, affixing to, gripping, or latching to an item, for which a flap may be implemented to provide a covering. The material used may be of various colors, patterns, dimensions and textures so as to complement or appeal to any user's style. There may also be ornaments or accessories such as beads, stones, studs, jewelry, letters, or things of the like appended to the material to give an added style detail. The material may be layered to yield an option for insertion of another material to yield a different desired texture or structural effect, such as insertion of removable cardboard for stiffening, or insertion of possibly removable batting for a cushioned or padded effect, and all other materials which could possibly be considered to provide a varying effect. The cover may also be reversible, where the cover could be easily turned and used inside out. The cover may also contain 3-dimensional aspects to display the shape of a character, an object, or an animal. The cover may be used to fully cover the item, or a portion thereof, including the interior and exterior, or the cover may be used for either the interior or the exterior of the item. Additionally, the cover may be dimensioned and configured to accommodate various sizes, function and material, and types of items, including but not limited to frames, vases, doors, boxes of any type and size, baskets, cups, doors, drawers, wastebaskets, napkin boxes, headrest, hampers, shoeboxes, computer monitors, televisions, storage trays, storage containers, table tops, chair tops/backs or seats, stools, lampshades, toasters, canisters, blenders, slow cookers, canisters, flowerpots, bottles, sewing machine, cabinets, bowls, ceiling fan blades, sun visors, steering wheels, vehicle mirrors (interior and exterior), toilet lids, storage shelves, wall units, ottomans, speakers, appliances, candle holders, electronic items, crates. The cover may also employ a fastener system to allow the use of interchangeable displays. Furthermore, assorted sizes, shapes, and dimensions of covers may be grouped together for use as a coordinating kit.

### BACKGROUND OF THE INVENTION

1. Field of the Invention

The present invention relates to covers for decorative and utilitarian purposes which are fitted onto 3-dimensional items for or connected to household, office or place of business items, and automobiles/vehicles.

2. Description of the Related Art

It is accepted that draped fabric has intrinsic aesthetic appeal as it relates to color, shadow and form which can enhance the appearance of items which it covers, creating a different desired effect. Hence, a rectangular frame, which has its own inherent emotional impact, can be transformed into a new object of decor by covering it.

Coverings placed upon household items serve not only the utilitarian purpose of protecting the item so covered, but can also enhance the beauty of the covered object and alternatively be used to direct, remind, and instruct, or convey a message to the onlooker through the appropriate choice of design and color. Furthermore, covers intended for a particular shaped 3-D item may be used for various items, thus being cross-functional, multi-purposed. Thus, a cover can be cross-functioned between an office chair-back and an automobile seat. A cover can also be cross-functioned between a car headrest and a car sun visor. A cover used for a table may also interchangeably be used for an ottoman. It is to the user's discretion as to what item or object the selected cover is to be used for.

Various cover types have been previously created, including U.S. Pat. No. 4,475,768 issued on Oct. 9, 1984 to Webb which yielded a fitted seat cover, using Velcro of the seat. Benefits of the cover include allowing the user to adapt the chair to its environment, or just change decor at a moment's notice through the use of different colors, patterns and textures

Loose furniture covers have been used for many years. Examples of these covers, and improvements thereof, include British Patent No. 1,143,275 issued to Andrew depicts a cover for an armchair, that in one embodiment uses a series of drawstrings to fix the cover around the arms and legs of the chair. Another example is British Patent No. 1.024,324 issued to Jenkins for improvements in loose covers for furniture, wherein a cover is secured in place by use of pins.

Covers have also been used to form household furniture out of more skeletal seating structures as in U.S. Pat. No. 4,225,179 issued on Sep. 30, 1980 to Visconti disclosing a removable furniture covering adapted to transform a simple chair, such as a deck chair, into a padded armchair.

Lampshade covers have been created in order to complement the decor of a room. As demonstrated in U.S. Pat. No. 6,857,766 granted to Gina M. Verdi, this cover could be used to add to the decor of a room, to provide a festive atmosphere during holidays, and to allow the user to reverse the cover inside out.

Special fabrics have also been created to allow for material to stretch to allow for a snug fit on covered objects, including furniture as demonstrated by U.S. Pat. No. 5,247,893 issued Sep. 28, 1994 to Zafiroglu.

Other types of coverings and improvements thereon have been the subject of patents, but are less related to the present invention, including U.S. Pat. No. 5,474,185 (protective packaging for furniture, electrical apparatus and the like) issued on Dec. 12, 1995 to Franke; U.S. Pat. No. 5,143,133 (furniture covering for shipment) issued on Sep. 1, 1992 to Speckman; U.S. Pat. No. 5,397,162 (saddle for a bicycle) issued on Mar. 14, 1995 to Huang; British Patent No. 328,436 (improvements in retainers for loose covers of seats and the like) issued to Flinn; and French Patent No. 1,297,454 for a type of seat covering.

Decorative covers for household items have also been previously patented, as in U.S. Pat. No. 5,922,437 issued on Jul. 13, 1999 to Monta S. Bryant. However, these covers were specifically for household items. In addition, they were not created to be transitioned between various items, but were created specifically for targeted items.

The present invention improves on the aforementioned in that it is multiuse, allowing the ability to transition decorative covers between various types of items, which brings a huge degree of versatility.

### SUMMARY OF THE INVENTION

The present invention is for decorative covers for household, office or place of business, and automobile related items. The decorative cover is created to give the user the capability if transforming the façade of an item without actually changing the intrinsic properties of the item itself. It is intended that such covers be attractive and artful, complementing the item in its environment, or instructive. The covers may even employ a hook and loop fastening system allowing interchangeable displays. For example, door covers may have attractive patterns or commemorate different holidays. Additionally, a door cover may provide highly visible instructions or other signs. Hanging mirrors and framed pictures can be transformed into whimsical decor which may be easily altered either by changing covers, or by attaching new designs to the cover via a fastener such as a hook and loop system. Household items, such as stem vases, may be made to have a bulkier appearance or receive added protection by adding a padded cover. Decorative trim may be added to complement the decor. Easy maintenance is assured by simply removing the cover and dropping it into a washing machine.

In all cases, the item covered provides the skeleton of the covered display, while the covering with its colors, style, textures, impressions and dimensions, and so contributes to the decor of the environment.

The present invention is intended to resolve issues related to what the user deems to be an eyesore. Items are sometimes placed in a room for a particular purpose other than decor, such as that which would be experienced in the case of electronics or storage items. If the user wanted to cover these items in such a way so as to satisfy the need for a universally decorative theme continuous within the associated space, this decorative cover provides the means for achieving this solution.

There exists a need for such a cover to appeal to the style and decorative taste of the user of by providing a convenient means of reconciling an object to the decor of the space in which it is placed.

The present invention gives the user the discretion to be able to use the cover for the item of the user's choice. The variation of shapes and dimensions of the covers provide a multifunctional element, interchangeable capability that can be transitioned to various items. Thus, a cover that may be suitable for a stool could also be used for a toilet seat, or an automobile steering wheel, as the dimensions and shape of these two referenced items are similar. A cover can be cross-functioned between an office chair-back and an automobile seat. A cover can also be cross-functioned between a car headrest and a car sun visor. A cover used for a table may also interchangeably be used for an ottoman. It is to the user's discretion as to what item or object the selected cover is to be used for.

Thus, the varying shapes and sizes of the cover will yield this element of flexibility to the user.

The present invention will provide the user with a turnkey, ready to use cover that can easily be placed on the user's chosen item without the need to sew material. The cover provides a preformed structure for the user.

Accordingly, it is a principal objective of the invention to provide a decorative cover for a wide variety of household, office or business, automobile related items, including, but not limited to, frames, vases, doors, boxes of any type and size, baskets, cups, doors, drawers, wastebaskets, napkin boxes, headrest, hampers, shoeboxes, computer monitors, televisions, storage trays, storage containers, table tops, chair tops/backs or seats, stools, lampshades, toasters, canisters, blenders, slow cookers, canisters, flowerpots, bottles, sewing machine, cabinets, bowls, ceiling fan blades, sun visors, steering wheels, vehicle mirrors (interior and exterior), toilet lids, storage shelves, wall units, ottomans, speakers, appliances, candle holders, electronic items, crates.

Thus, It is a further object of this invention to provide the cover with patterns, details and/or color to complement the area of the space wherein the 3-Dimensional item is placed.

It is another objective of the present invention to provide the user with an option to reverse the cover and flip it, making it also usable inside out.

It is also an objective of the present invention to give the user the opportunity to insert material into layers of covering, including cardboard or padding, to yield a varying structured effect within the cover

It is another objective of the invention to provide highly visible instructions, labels, messages or signs.

It is a further objective of the invention to be easily maintained and transformed to provide a dynamic environment.

It is an objective of the invention to provide improved elements and arrangements thereof for the purposes described which is inexpensive, dependable and fully effective in accomplishing its intended purposes.

It is another objective of the present invention to provide an option for an appended pocket for storage of displayed or non-displayed items.

An additional objective of the decorative cover invention is to provide a means of giving the user an option for customization or personalization of the cover. For example, the user may use a cover that contains personalized embroidery, written messages, labeling, or customized pictures or design specific to the user's preferences.

These and other objectives of the present invention will become readily apparent upon further review of the following specification and drawings.

### BRIEF DESCRIPTION OF THE DRAWINGS

FIG. 1 is a front view of a fitted cover with an elastic edge placed over a rectangular mirror.

FIG. 2 is a front view of a fitted cover with a free edge over a rectangular frame

FIG. 3 displays a 3-dimensional, fully enclosed cover over a 3-dimensional (rectangular) item using a zipper for enclosure.

FIG. 4 displays a fitted cover with an elastic edge over a chair back/top.

FIG. 5 displays a fitted cover over an ottoman or table using elastic on inner edge for fitting.

FIG. 6 displays a fitted cover placing over a rectangular box incorporating a fastening system.

FIG. 7 displays a free edge fitted cover placing over a lamp.

FIG. 8 displays a fitted cover with drawstring edge placing over a flowerpot.

FIG. 9 displays an overall a bottom view of a fitted cover with an insert pocket over a 3-D item.

FIG. 10 displays a fitted cover with elastic edge over a drawer, with aperture for hardware.

FIG. 11 displays four fitted covers to be used within a vehicle, including cover over the exterior mirror with a free edge, a cover over the sun visor with an elastic edge, a cover over the headrest and a cover over the seat, both with elastic edges.

### DETAILED DESCRIPTION OF THE PREFERRED EMBODIMENTS

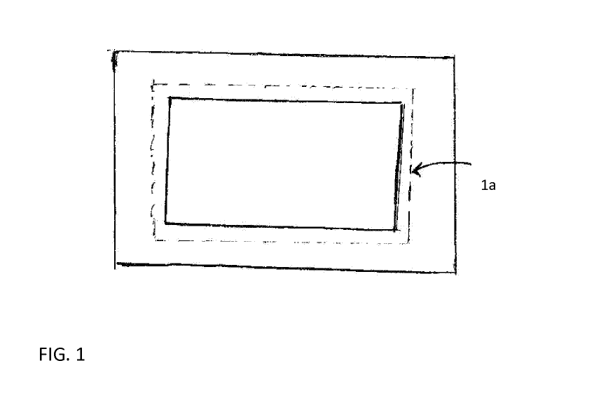

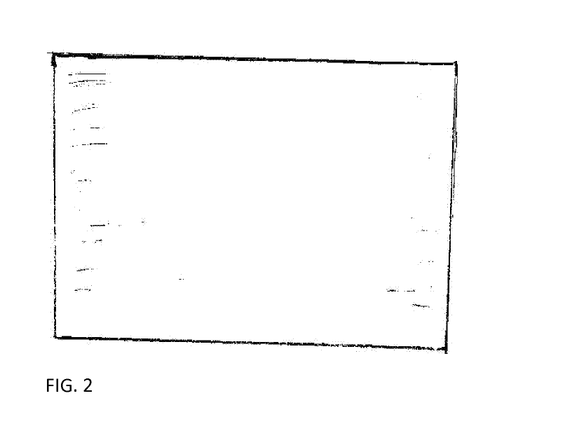

Referring now to the Figures and numerals of reference, the present invention comprises a fitted cover for any variation of assorted 3-dimensional items. FIGS. 1 and 2 depict a front view of a covered mirror (FIG. 1), incorporating present invention, and rectangular frame (FIG. 2), respectively. The present invention cover is made from a pliable material which may be shaped roughly like a bag, comprising an opening having a continuous edge 1a. The edge (1a) contains a stitched hem with a hollow opening to form a channel. The channel provides a housing and thus a means for securely adjusting the cover on the mirror (FIG. 1), frame (FIG. 2) or other item to be covered. The means for adjusting contained within the channel 1 in this case is an elastic strip housed within a formed channel as can be seen in FIG. 1 (1a). FIG. 2 makes use of the same, wherein the channel is not shown, but the majority surface of the cover is used as the decorative means. The cover depicted in the applications referenced is of a rectangular shape, and may thus also be used similarly for a table top, a door, or a flat television, or for any other item of similar dimensions wherein the user may deem plausible. The material used may be decorative, a message displayed, labeling or other instructions, or may even be equipped with a mechanism to allow interchangeable displays wherein the one fastener portion is attached to a display item and the other fastener portion is attached to the cover. Display items might include wreaths, photographs or other similar thematic items.

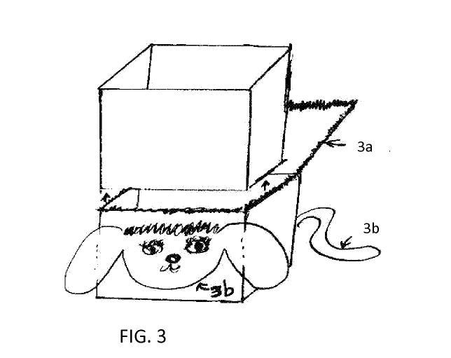

FIG. 3 depicts a square-like box shaped cover wherein the cover is actually designed to form a full enclosure of the particular 3-dimensional item. The cover also has in this instance a 3-dimensional design element displaying a character/animal (3b). The cover is made of a pliable material, and consists of an opening and closing mechanism, such as a zipper (3a), button, Velcro, etc., in order to form an enclosure, or the cover may also be designed to remain freely open. The cover depicted could be used for any box of a similar shape, used for any purpose. It could be used to cover a plain cardboard box, a jewelry box, or a storage container, and thereby transforming the reveal of the covered item. The cover could be used for any item for which the cover fits, and the decision for which item to cover being left to the user's discretion. The cover is placed over top of box, or box is inserted into cover, as depicted in FIG. 3.

FIG. 4 depicts a rectangular shaped cover used to cover the back or top portion of a chair. This cover is also a bag shaped structure, but in this instance, the opening of the cover is narrower, and the length and width dimensions of the cover are symmetrical. The cover is made of a pliable material, and the edge of the cover conceals an elastic strip within a formed channel. This cover could be interchangeable between household chairs and seating, office chairs, or applications wherein the item is similar in shape or dimension. The cover may incorporate an optional padding element to provide a varied texture.

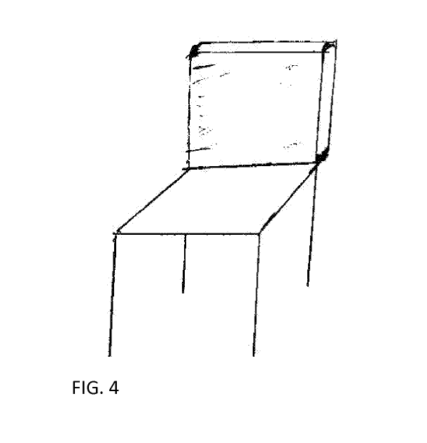

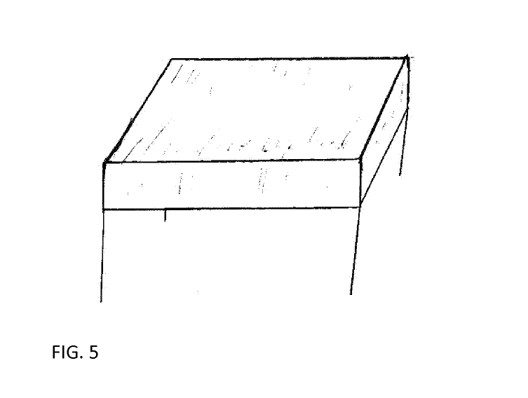

FIG. 5 depicts a rectangular shaped cover begin used to cover an ottoman. As shown, the decorative cover is a bag shaped structure, and the reveal when covering the ottoman would comprise the majority of the material used to form the cover. The underpinning portion under the bottom of the ottoman is where the edges of the cover would be concealed. This application could make use of an elasticized edge, an edge with channel containing a drawstring closure, or an edge that doesn't contain a channel. The interior portion of the edge(s) may contain a component for adhesion, affixing to, or latching to the ottoman. This application could also be used with items of similar dimension such as a table, or any other similarly shaped item. The picture depicted shows a rectangular shaped ottoman. However, the application would work similarly for that of a round ottoman, with a round shaped cover, and thus could be translated to a cover for a stool or a toilet seat.

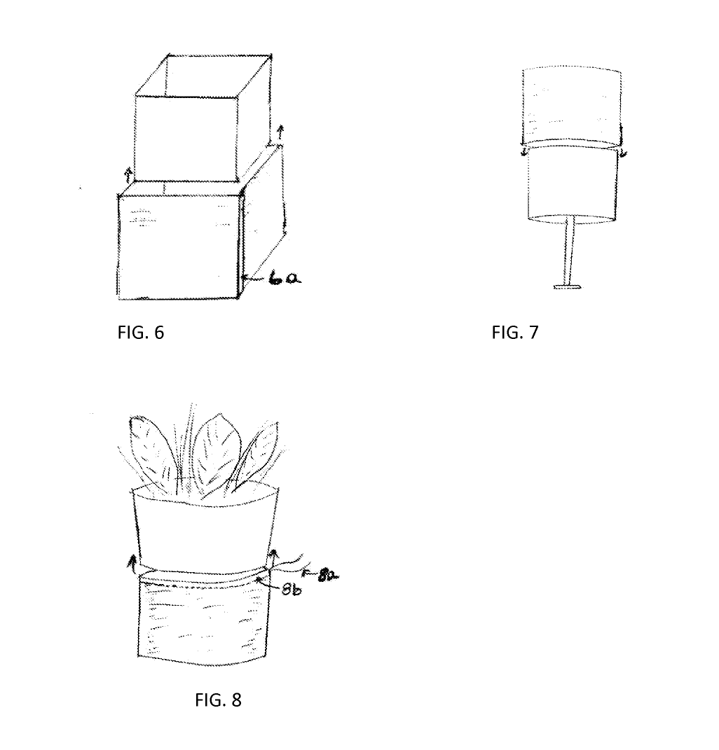

FIG. 6 shows a kit component connected together to form a cover. In this instance, the cover uses concealed adhesive strips (6a) to attach each paneled side to the other to form the complete cover. The opening in this instance does not contain a channel, but does not necessitate an additional securing component to fit the item. As can be seen from the various figures, the covers may come in a variety of shapes and sizes, as well as patterns. The covers may also be grouped in predetermined sizes, as kits. These kits may coordinate the covers so as to create a harmonious decor. The panels for the kits could be mixed and matched differently to suit the user's creative taste.

FIG. 7 depicts a cover being used to change the decor of the reveal of a lampshade. The cover shown is made of a pliable material and forms a continuous cylindrical shape that can easily be slid over any lamp shade to reveal what appears to be a totally different lampshade based on the decor of the cover. This application may incorporate an elasticized edge, a drawstring edge, or it may be a free edge with concealed mechanism for affixing or attaching to the covered item. This application has 2 open edges, one at the top and one at the bottom of the cover and can easily be translated to a vase, a wastebasket, a canister, or any other similarly shaped item.

FIG. 8 depicts a cover being used for a flowerpot. This application would be a slight variation from that used in the case of a lampshade, wherein this application makes use of a cylindrically shaped cover that has only one opening as opposed to 2, and it makes use of an drawstring securing mechanism (8a) enclosed within a channel (8b). This cover choice could be used also for a vase, a wastebasket, a canister, and similarly shaped items.

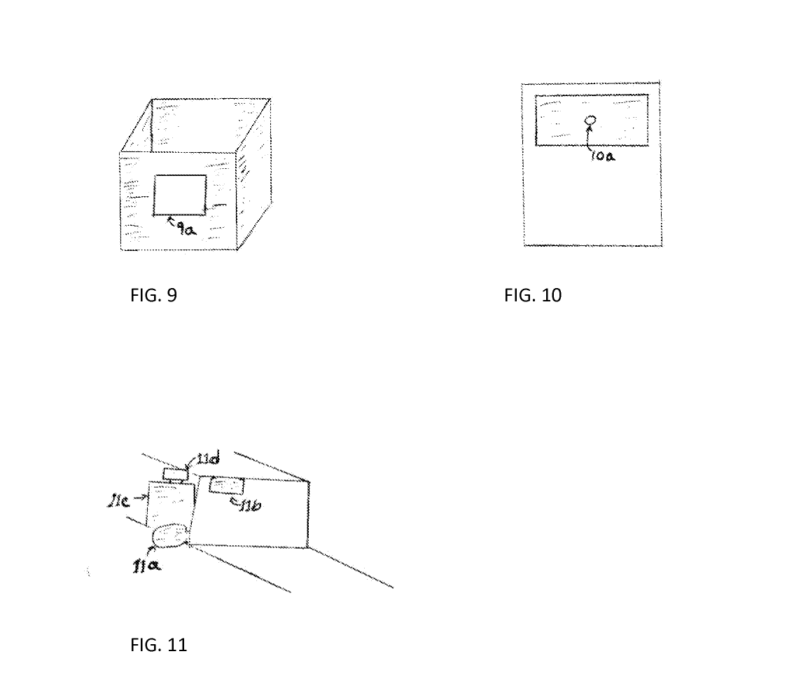

FIG. 9 reveals an application where a square-cube shaped cover is placed over a square box-shaped item. The cover is cube liked shaped, with one opening. The opening in this instance does not contain a channel, but instead makes use of a component for adhesion, affixing to, or latching to the item, for which a flap is implemented to conceal. This application could be used for a storage box or container, a basket, a crate, or any other similarly shaped item. The representation shown also displays a pocket (9a) to house pictures, other items for display, or to store non-displayed items.

FIG. 10 shows a decorative cover being used to change the reveal of a drawer. The cover is made of pliable material, and uses an adhesive mechanism for affixing to the drawer. The majority of the material used for the cover is revealed, and small section wraps around the edges of the drawer, to establish a means for securing the cover to the drawer. An elastic edged cover could also be used in this application. A small hole (10a) could be punctured into the cover should the drawer necessitate a means for placing hardware. The application could also be used for cabinetry as well as for sun-visor, and any other items similar in shape.

FIG. 11 displays the uses of the cover invention for automobile related applications. The depiction shows covers on the exterior mirror (11a), the interior sun visor (11b), the seat (11c), and the head rest (11d). These would all make use of an elasticized edge or an adhesive or latched edge. Covers of this shape and structure could also be used in other applications for items of similar shapes.

To use a multiuse configured cover, one need only place a suitably shaped associated 3-dimensional item inside the opening and either pull the drawstring taut, let the elastic close in around the item, use the adhesive or gripping mechanism to secure it, or just slide the cover on and adjust so that it fits neatly.

The Figures represent only a small portion of 3-dimensional items that may be covered by the present invention, and are not meant to exhaust the list of items that possibly may be used in conjunction with the present invention. Various design choices would be made available for every option.

It should be understood that the foregoing description is only illustrative of the present invention. It is to be understood that the present invention is not limited to the sole embodiment described above, but encompasses any and all embodiments within the scope of all associated claims. Various alternatives and modifications can be devised by those skilled in the art without departing from the invention. Accordingly, the present invention is intended to embrace all such alternatives, modifications and variances.

1. An adjustable fitted cover in combination with a 3-dimensional item, said combination comprising:
a 3-dimensional item having a length, a width, and a depth, or a diameter and a circumference (depending on the shape of the item); a cover composed of a sheet of pliable material comprising a dimensioned and configured structure, said sheet covering the 3-dimensional item, said sheet having a continuous edge creating an opening tailored for passing a portion of the 3-dimensional item through, said sheet having decorative facade
said opening(s) could consist of an opening and closing mechanism, such as a zipper, button, Velcro, etc., in order to form an enclosure, or it also may be designed to remain freely open;
said cover may have a channel along said edge(s) and said opening(s), said channel(s) being constructed by stitching said sheet upon itself, said channel(s) being disposed in a loop on the unexposed (interior, rear, or bottom) portion of the 3-dimensional item;
a securing means possibly consisting of a drawstring and/or an elastic strip, said securing means being enclosed within said channel;
said cover may have a free edge exterior, without the incorporation of a securing channel, but may use as a securing means a component for adhesion, affixing to, gripping, latching to or strapping on an item, for which a flap may be implemented for concealing purposes;
said cover may have a free edge exterior, and be fitted to an item without necessitate any channel housed or additional securing mechanism;
said cover including a possible hardware aperture wherein hardware may be projected through.

2. The combination according to claim 1, wherein said channel has at least one aperture as a point of entry, and once 3-dimensional item enters the cover, it is then fully engulfed and enclosed within said cover, with means of secure enclosure comprising closing mechanism, such as a zipper, button, Velcro, or some other means of completely sealing the open edge of said cover

3. The combination according to claim 1, wherein said channel has at least one aperture as a point of entry, and said securing means comprises a drawstring laced through said channel at the point of entry until it re-emerges through opening

4. The combination according to claim 1 wherein said means for adjusting said cover on 3-dimensional item comprises an elastic strip contained entirely within said formed channel.

5. The combination according to claim 1 wherein said decorative facade is chosen from a selection of colors, patterns, textures, styles and dimensions.

6. The combination according to claim 1 incorporates a fastening system used in combination with a 3-dimensional item, wherein the system comprises a fastening mechanism to attach panels to each other to form a complete cover, or the panels may be attached to each dimension of the 3-dimensional object to yield the effect of a complete cover.

7. The combination according to claim 1 wherein said cover has a free edge exterior, without the incorporation of a securing channel, but uses as a securing means a component for adhesion, affixing to, gripping, latching to or strapping on an item, for which a flap may be implemented for concealing purposes.

8. The combination according to claim 1 wherein said cover is reversible where interior of cover and exterior of cover can be used interchangeably, the result revealing a different façade once reversed.

9. The combination according to claim 1 wherein the material of said cover may be layered to yield an option for insertion of another material to yield a different desired texture or structural effect, such as insertion of removable cardboard for stiffening, or insertion of possibly removable batting for a cushioned or padded effect, and all other materials which could possibly be considered to provide a varying effect.
